(19) United States
(12) Patent Application Publication
(10) Pub. No.: US 2006/0236845 A1
(43) Pub. Date: Oct. 26, 2006

(54) Universal method and apparatus for mutual sound and light correlation

(76) Inventor: Siir Kilkis, Vienna, VA (US)

Correspondence Address: NIXON & VANDERHYE, PC, 901 NORTH GLEBE ROAD, 11TH FLOOR, ARLINGTON, VA, 22203, US

(21) Appl. No.: 10/568,768

(22) PCT Filed: Aug. 17, 2004
(86) PCT No.: PCT/IB04/51476

§ 371 Date: Feb. 21, 2006

Related U.S. Application Data
(60) Provisional application No. 60/495,971, filed on Aug. 18, 2003.

(51) Int. Cl. G10H 1/00

(52) U.S. Cl. 84/600

(57) ABSTRACT

Method and apparatus utilizing the method for continuous correlation of sound to light and light to sound, and more particularly a method based on a universal equation such that it can be applied to all wavelengths of light and sound seamlessly without any intuition or subjective inputs. Within this method, the entire audible sound spectrum mutually correlates to the entire visible light spectrum. A light and sound correlation apparatus disclosed is an apparatus where the wavelength of light and/or sound is input and the correlating sound and/or light is output. This invention is revealed in a plurality of embodiments for human needs, such as providing an interactive color and sound correlation display apparatus and slide rule, a color MIDI file generating apparatus, a colorized visual orchestration apparatus, an art composer apparatus, spatial information apparatus with color and sound, and a color language apparatus.

### TECHNICAL FIELD

The present invention relates to a method, and an apparatus exploiting said method, for continuous correlation of sound to light and light to sound.

### BACKGROUND ART

Since ancient times, it has been a desire and need of humankind to associate colors and sounds and pursue its benefits. Even today, such efforts remain intuitive and subjective with one thing in common: they reflect a need of humankind but are not capable of being consistently applied to all colors and sounds humans can see and hear. This is a result of the lack of science in these efforts. If a universal correlation had been found, then the entire audible range could correlate to the visible range without any human intervention or modification. Such a correlation must be seamless in order to have a continuous dialogue between light and sound to address human needs.

Current continuations of intuitive and subjective efforts are exemplified in several patents, which all rely on a user dependent relationship. At best, an association, not a correlation is made relative to a reference sound frequency or color.

U.S. Pat. No. 6,686,529 B2 (2004) employs an equation to convert one signal of the audible frequency into a signal of a visible frequency, which involves a reference visible frequency (Fl, fl) to be inputted by the user and employs arbitrary color harmony schemes. In addition, the method involves selection of a reference color from a table or a scale degree-dividing rate and modifies frequencies to fit the audible and visible ranges. Hence, this method proposes a user input dependent color and sound conversion criterion rather than a universal correlation equation.

Another prior art document, namely U.S. Pat. No. 4,378,466 (1983) discloses a method for conversion of acoustic signals into visual signals, wherein each audio frequency is assigned a respective color hue. This method also involves an artificial assignment procedure among colors and sounds.

A sound-picture converter is explained in Japanese Patent 63,184,875, (1988) wherein each element picture is allowed to correspond to a tone color, and each element of the picture is converted to sound based on the said correspondence. A similar converter is disclosed in another Japanese Patent 3,134,697 (1991).

A PCT application no. WO 81/00637 (1981) discloses a visual method of representing sound by color, consisting of a subjective division of the color spectrum into twelve hues and correlating each of the twelve notes of the musical octave with each hue in such a way that degrees of consonance and dissonance between notes are claimed to correlate with that between the corresponding colors.

Japanese Patent 01,091,173 A2 (1989) allows MIDI (Musical Instrument Digital Interface) signals of a music piece to be displayed on a TV (cathode ray tube) screen in terms of pictures of four basic types of musical instruments, i.e. piano, strings, horns, and rhythm instruments. An electronic circuit processes the MIDI signals to display the corresponding musical instrument pictures simultaneously with the music. This patent simply allocates MIDI signals to their corresponding music instrument displays and does not involve a color sound correlation whatsoever.

Japanese Patent 22,000,734 A2 (2002) describes a musical therapy support device, which accompanies a screen output for the music being played by processing its MIDI signals. This device is not based on any scientific color-sound correlation.

Japanese Patent 04,170,574 A2 (1992) describes a method for playing a color-classified instrument by a color-classified score. According to this patent, different colors are assigned to different notes of music, and a music instrument with colored keys is played accordingly. The color assignment in this patent does not involve any scientific color-sound correlation.

U.S. Pat. No. 6,515,210 B2 (2003) issued to Shibukawa discloses a musical score displaying apparatus and method for a keyboard with a color monitor. On the color monitor, a prearranged color appears indicating which key to be pressed in performing a music piece.

In U.S. Patent Application 2004/0061668 A1, Lin describes a LED (Light Emitting Diode) based lighting apparatus operated in synchronism with the music played. This apparatus is primarily intended for entertainment where LED colors and brightness change with the frequency of sound. In this apparatus, the LED color and brightness selection were arbitrarily.

In U.S. Patent Application 2003/0117400 A1, Steinberg et al. disclose an apparatus which utilizes a color palette to display musical notation on a color monitor or display screen with various combinations of user selected and adjusted colors, shapes, patterns etc.

In U.S. Patent Application 2004/0074376 A1, Varme discloses a system to colorize musical scores through a septuary system of colors based on an arbitrarily selected master color matrix.

U.S. Pat. No. 5,998,720 (1999) issued to Beatty discloses a music teaching system and method comprising at least two musical instruments. Each musical instrument has a mechanism for producing a musical note when the means is activated. Each such mechanism is marked by a color corresponding to the particular musical note produced by the mechanism. In this method, the color sound association was determined arbitrarily simply to allow students with color-coded hand bells to follow color-coded cards displayed by the teacher.

U.S. Pat. No. 5,931,680 (1999) issued to Semba discloses an apparatus for displaying beat marks corresponding to the number of beats per measure during a performance by a musical instrument karaoke apparatus. Color of each displayed beat marks change color in synchrony with the timing of beats. The color change method does not involve a scientific color-sound correlation; instead, colors simply change with a predetermined direction with the tempo of music.

In U.S. Patent Application 2004/0007118 A1, Holcombe describes a method of music notation, which assigns distinct colors to the twelve notes of the C major scale. Color boxes are embedded in the conventional notation sheets. In this method, the color assignments have been arbitrarily selected.

U.S. Pat. No. 6,660,921 B2 (2003) issued to Deverich discloses a method for teaching stringed instrument students how to play sheet music by using colored fingering numbers. In this method, “easily identifiable” distinct colors were arbitrarily assigned to particular notes.

The common denominator of all the above prior art is the fact that the color sound associations were made arbitrarily and none of them agree with another. Furthermore, the direct correlation between the replication pattern of octaves in music and the replication of spectral colors with different shades was neither recognized nor fully utilized.

None of the documents in the prior art disclose a scientific and natural correlation between sound and light; instead, they stem from intuitive and artificial conversions.

On the other hand, in the human brain, the color response subfields are arranged from low frequency (red) to high frequency (violet). Similarly, each subfield in the human brain for sound responses is arranged from low to high frequency. This indicates that there is a natural correlation between the biological sequencing of light and sound waves, which was failed to be disclosed in prior art documents. If a color sound correlation is to be used for human oriented applications, it must represent and appeal to this natural correlation. However, up to present such a natural correlation was deemed impossible.

### BRIEF DISCLOSURE OF THE INVENTION

The object of the present invention is to establish a direct and unique correlation between the wavelengths of visible light and audible sound in a seamless, continuous, and objective manner.

Another object of the present invention is to effectively recognize and utilize the natural human color and sound cognitions.

Still another object of the present invention is to provide a natural correlation between wavelengths of sound and light.

Still another object of the present invention is to develop a mutual sound and light correlation method and apparatus that is universal, i.e. that can be applied to all wavelengths of light and sound, without any user intervention or dependency.

The aforementioned objects are mainly achieved through a method utilizing a continuous function, which seamlessly correlates wavelengths of light to sound and sound to light.

According to present invention, a method based on a universal equation, which correlates sound and light waves continuously and seamlessly for the first time, is disclosed. Within this method, the entire audible sound range mutually correlates to the entire visible light range without any human intuition, subjective inputs, or reference point selections. This method uniquely recognizes the natural correlation in the human brain.

The invented method is also utilized in a light and sound correlation apparatus wherein the wavelength of light and/or sound is input and the wavelength of correlating sound and/or light is output along with other relevant data.

A plurality of embodiments for human needs is possible thanks to the special attributes of the invention, e.g. human cognition oriented, continuous, and seamless. Examples to these embodiments include innovative solutions for the hearing or visually impaired as well as providing creative devices in music education.

In an aspect of the invention, the method is utilized for producing a 3-D color sound correlation display apparatus for illustrative and educational purposes, which comprises layers of color chromaticity diagrams for different perceived brightness of colors superimposed with the continuously correlating sound data. This diagram can be in any physical or electronic format.

In another aspect of the invention, the method was utilized for producing a color and sound correlation slide rule apparatus for referral, animation, illustration, and education purposes, which comprises a combination of moving and stationary parts. The slide rule apparatus audibly and/or visually shows the color and sound correlation in any input order.

In still another aspect of the invention, the method and apparatus is utilized for generating sound and light correlation of music. A new CMIDI (Color MIDI) file generating apparatus establishes a dynamic coupling among sound and light data. Sounds of each instrument or voice per each time increment are coupled with correlating light data. This file is an array of color and sound data, which can be output to any storage, retrieval, printing, transmitting, display, or animation device, depending on the desired form of output.

In still another aspect of the invention, the method and apparatus is utilized to provide a visual orchestration apparatus where the sounds produced by instruments are dynamically displayed with colors on an instrument layout. This layout has at least two dimensions and maps at least one music instrument, voice, and/or sound sources. The present invention, which consists of a continuous correlation between sound and light, can colorize all sounds. Hence, a visual orchestration of any combination of instruments and/or sounds sources are possible.

In still another aspect of the invention, the method and apparatus is utilized to produce an art composer apparatus, which generates orchestral sounds correlated with colors in a visual image. An art composer apparatus comprises color inputs for each incremental grid surface area of the image. The color inputs corresponding to each grid surface area are assigned to orchestral instruments and processed by a light and sound correlation apparatus.

In another aspect of the invention, a method and apparatus that produces sound data incorporating three-dimensional spatial information of an object is provided. The spatial information of an object is derived from the fact that the shades of colors change with depth. This apparatus is especially designed for individuals with William's Syndrome who have exceptional music ability but poor perception of depth.

In another aspect of the invention, a visual orchestration apparatus is utilized to provide a color language apparatus to aid perception of music played on any AV (audio-visual) apparatus, such that in analogy to sign language, a hearing impaired can visually follow sounds in a music performance on a TV screen, on which a picture in picture box dynamically displays the visual orchestration simultaneously with the main broadcast.

### DETAILED DISCLOSURE OF THE INVENTION

The file of this patent contains some drawings in color. Copies of this patent with color drawings will be provided in the national phase if requested.

The above object, and other features and advantages of the present invention will become more apparent after a reading of the following detailed description when taken in conjunction with the accompanying drawings, in which:

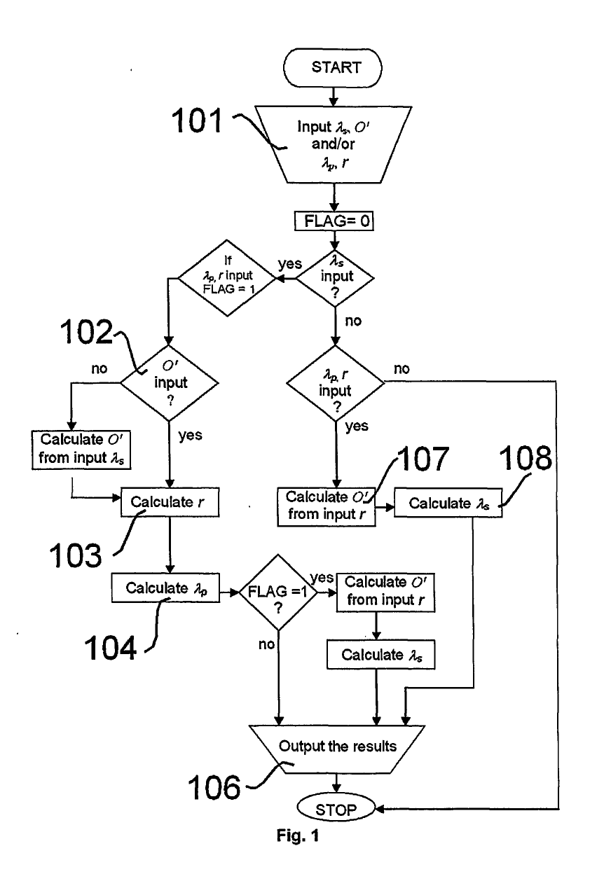

FIG. 1 shows a flowchart of the present method;

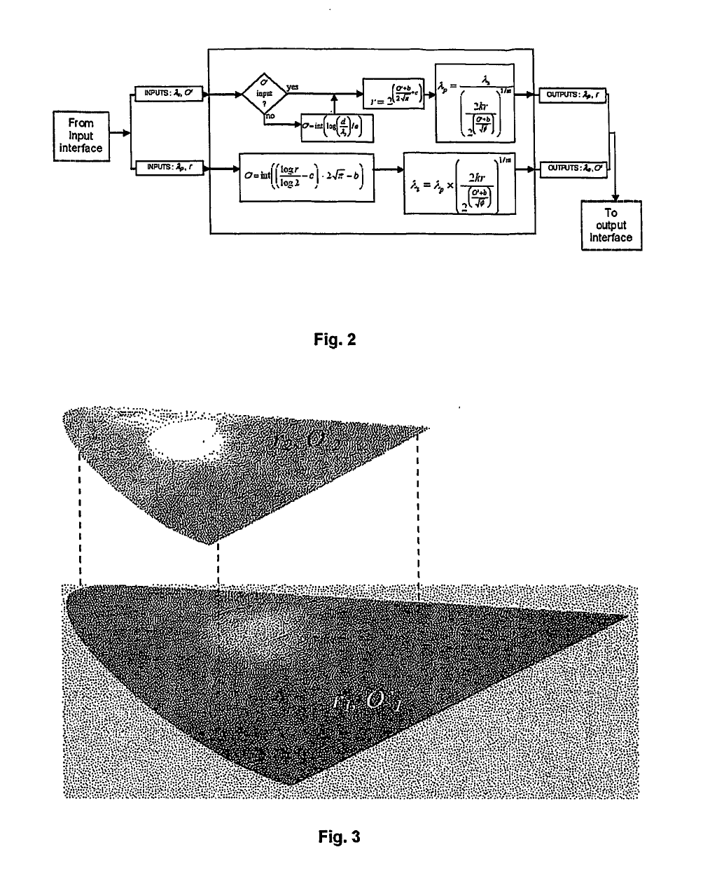

FIG. 2 shows a block diagram of the present light and sound correlating apparatus;

FIG. 3 shows a typical construction step of a color and sound correlation display apparatus according to the present invention;

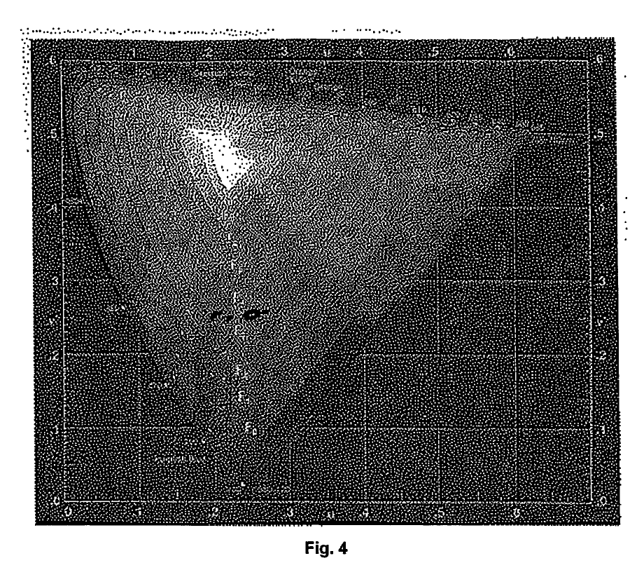

FIG. 4 shows a color and sound correlation display apparatus according to the present invention;

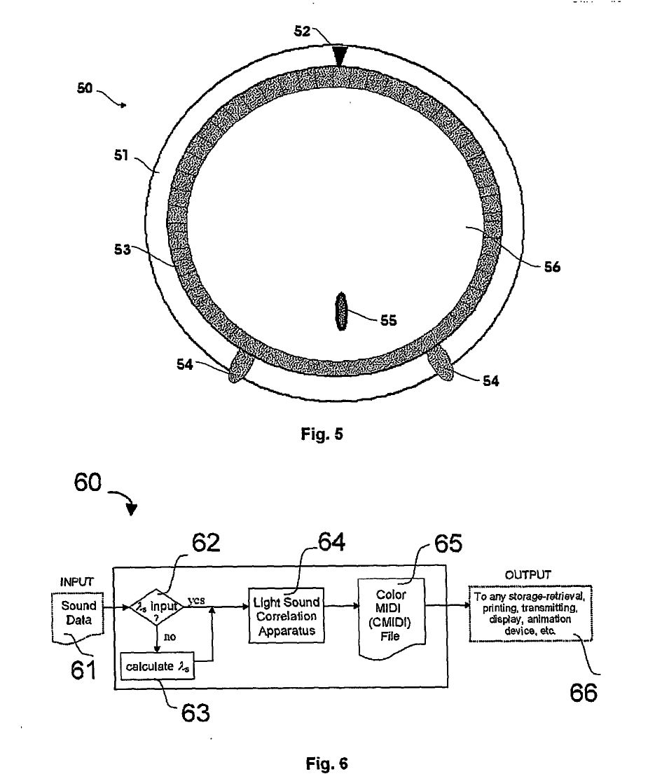

FIG. 5 is a schematic view of the color and sound correlation slide rule apparatus according to the present invention;

FIG. 6 is a block diagram of the color MIDI (CMIDI) file generating apparatus according to the present invention;

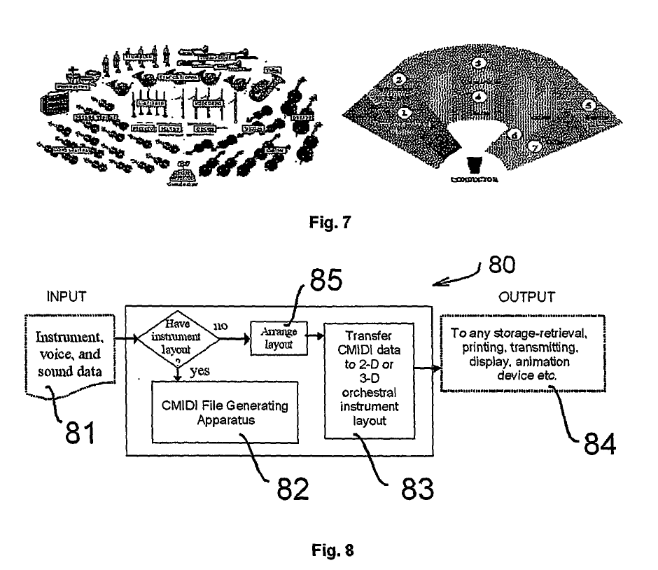

FIG. 7 shows an orchestral instrument layout and the digital simulation of that layout with section numbers according to the present invention;

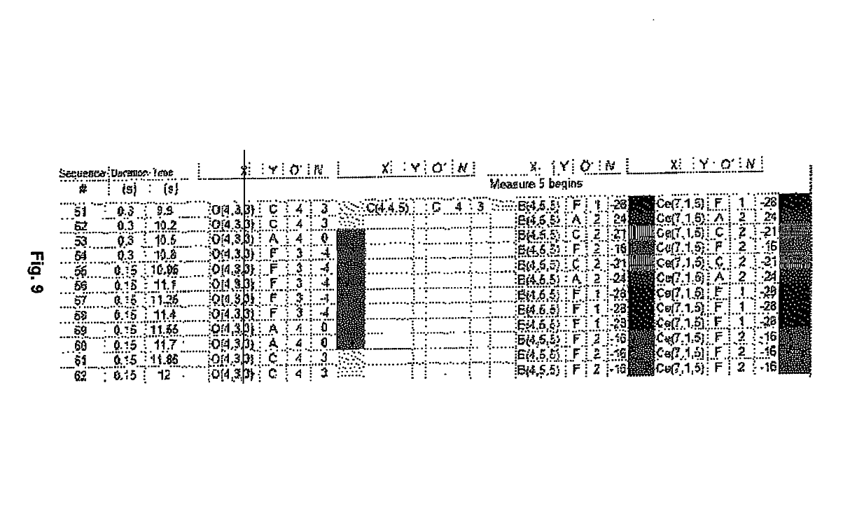

FIG. 8 shows a block diagram of a visual orchestration apparatus according to the present invention;

FIG. 9 is a table showing a sample CMIDI file for a number of instruments in an orchestra according to the present invention;

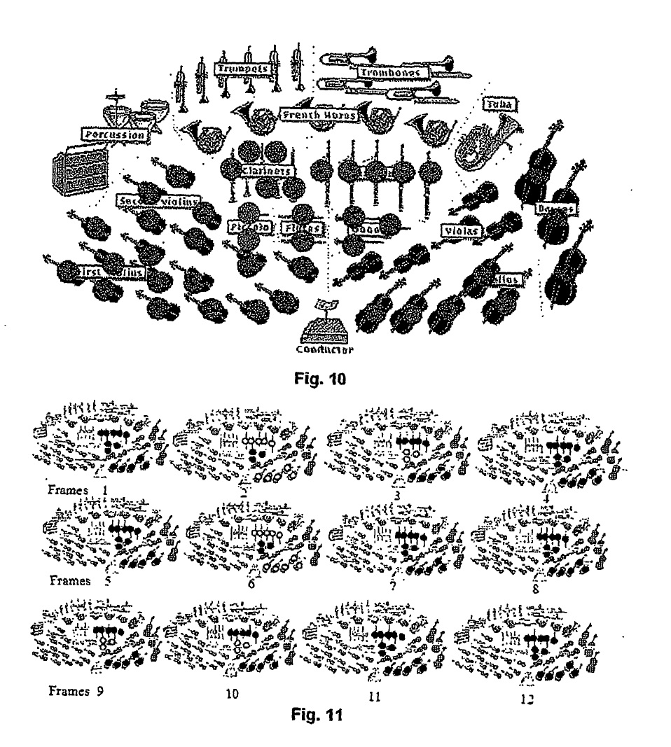

FIG. 10 shows a resulting view corresponding to one time frame of a generated CMIDI file according to the present invention;

FIG. 11 shows a series of views corresponding to a series of time frames of a generated CMIDI file according to the present invention;

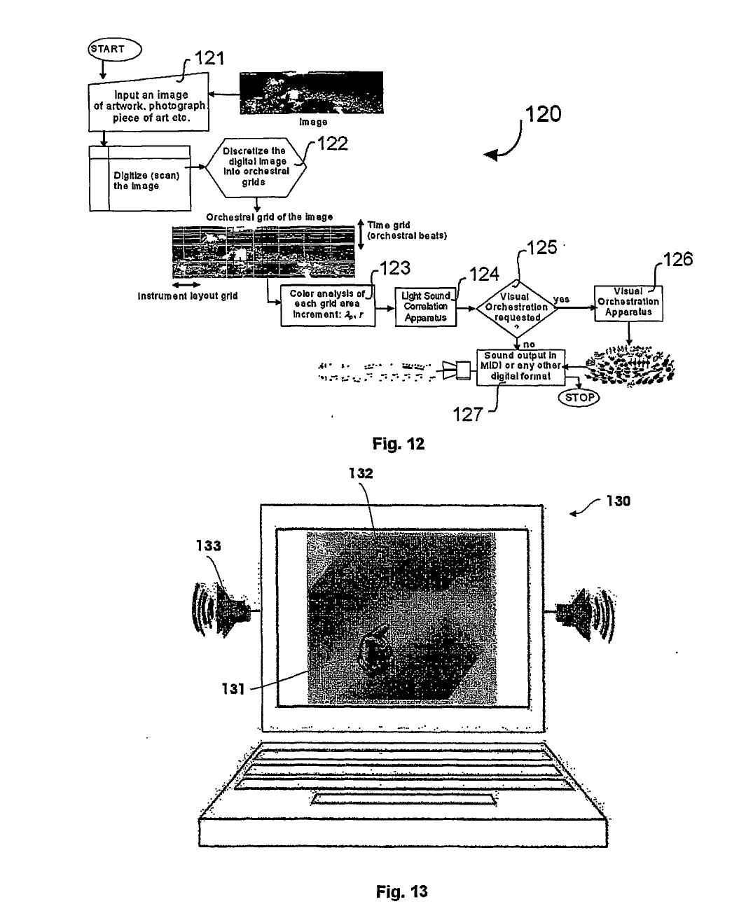

FIG. 12 shows a flowchart of an art composer apparatus according to the present invention;

FIG. 13 shows another embodiment of a present invention for a spatial information apparatus with color and sound for individuals with William's Syndrome according to the present invention;

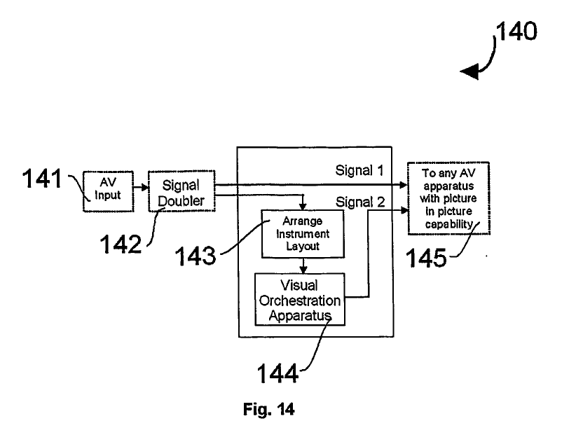

FIG. 14 shows a block diagram of a color language apparatus according to the present invention.

In an aspect of this invention, there is provided a method comprising a power ratio between sound wavelengths (λₛ) and light wavelengths (λₚ) that is proportional to a unique correlation number k,

$$( \frac{a}{r} ) \frac{{λ}_{s}^{m}}{{λ}_{p}^{n}} = k$$

such that λₛ can be any wavelength of sound and λₚ can be any wavelength of light. The variable a is a term that relates sound wavelengths to an octave system and r is a number that represents the perceived brightness of light. Powers of the ratio m and n are numbers between 0.2≦m≦2and 0.2≦n≦2.

As another aspect of this invention, k is the only consistent correlation number that is unique among all wavelength combinations of note sounds and colors and reveals a continuous, seamless, and mutual correlation between light and sound. The correlation number k is related to a ratio of light and sound velocities.

This method eliminates imposing any harmony that is based on human experience or choice, and thus brings complete universality and objectivity. Hence, the method based on this equation eliminates all concerns regarding any need for subjective inputs, references, selections, and user-based options.

In an aspect of this invention, a is correlated to a number O′ which relates any sound to an octave:

$$a = 0.5 \times {2}^{( \frac{O + b}{\sqrt{ϕ}} )} ,$$

Here, φ is the Golden Ratio and O′ is given by:

$$O = int ( log ( \frac{d}{{λ}_{s}} ) / e ) ,$$

In the above equations, b, d, and e are numbers between −5≦b≦5, 0.05≦d≦40, and 0.1≦e≦1.

In an aspect of this invention, r is correlated to O′ as given:

$$r = {2}^{( \frac{O + b}{2 \sqrt{π}} + c )} ,$$

Where c is a number between −2≦c≦2.

Hence, the present method uniquely and seamlessly correlates any light wavelength to a sound wavelength as:

$${λ}_{p} = \frac{{λ}_{s}}{{( \frac{2 kr}{{2}^{( \frac{O + b}{\sqrt{ϕ}} )}} )}^{1 / m}} ,$$

And the present method uniquely and seamlessly correlates any sound wavelength to a light wavelength as:

$${λ}_{s} = {λ}_{p} \times {( \frac{2 kr}{{2}^{( \frac{O + b}{\sqrt{ϕ}} )}} )}^{1 / m} ,$$

Hence, in its most basic form, the present method comprises the following steps:
inputting at least one wavelength, wavelength of light (λₚ), r and/or wavelength of sound (λₛ);
calculating the corresponding wavelength of sound and/or light using a single equation:

$$( \frac{a}{r} ) \frac{{λ}_{s}^{m}}{{λ}_{p}^{n}} = k$$
outputting the calculated wavelength.

In another embodiment (FIG. 1), the present method comprises:
inputting at least one wavelength, wavelength of light (λₚ), r and/or wavelength of sound (λₛ) (101);
if λₛ is an input (101),
checking whether O′ is an input (102);
if O′ is not an input, calculating O′ from the equation (103):

$$O = int ( log ( \frac{d}{{λ}_{s}} ) / e ) ,$$
calculating r from O′ using the equation (104):

$$r = {2}^{( \frac{O + b}{2 \sqrt{π}} + c )} ,$$
then calculating the corresponding wavelength of light using the equation (105):

$${λ}_{p} = \frac{{λ}_{s}}{{( \frac{2 kr}{{2}^{( \frac{O + b}{\sqrt{ϕ}} )}} )}^{1 / m}} ,$$
outputting the calculated wavelength of light (λₚ) and r (106).
if λₚ, r are inputs (101);
calculating the O′ using the equation (107):

$$O = int ( ( \frac{log r}{log 2} - c ) \times 2 \sqrt{π} - b )$$
then calculating corresponding wavelength of sound using the equation (108):

$${λ}_{s} = {λ}_{p} \times {( \frac{2 k r}{{2}^{( \frac{O + b}{\sqrt{ϕ}} )}} )}^{1 / m}$$
outputting calculated wavelength of sound (λₛ) and O′ (106).

An apparatus exploiting the present method may be any device capable of performing above calculations (FIG. 2). The said apparatus may be mechanical, electromechanical, electric, electronic, analog, digital, and/or hybrid. Examples may be an electronic card, a microprocessor, a computer, etc.

The inputs to the apparatus may be realized through any interface, such as a keyboard, keypad, a mouse, a device measuring wavelength of sound and/or light, a touch-screen, a graphics interface, sensor, light and sound transducer measurement device, etc.

The outputs from the apparatus may be in the form of a sound and/or light generator and/or graphics generator, e.g. full-light spectrum lamp(s), an LCD screen, monitor, TV, loudspeakers, electronic piano, keyboard, etc. and any other suitable device.

Various embodiments of the present method and apparatus are possible, only a few of them being mentioned here for the sake of illustration.

In one embodiment of the invention (FIGS. 3 and 4), the method and/or apparatus is utilized for producing a 3-D color sound correlation display apparatus for referral, illustrative and educational purposes. A basic diagram of the 3-D color and sound correlation display apparatus is constructed according to the present method, showing the entire audible range superimposed on several layers of the visible light gamut. In FIG. 3, the contour of each layer denotes the wavelengths of the visible spectrum. A layer is constructed for each octave with the corresponding perceived brightness and then these layers are superimposed in terms of various relationships of the correlation to produce the final diagram (FIG. 4). All wavelengths of audible sound can be displayed or marked on the correlating wavelength of the visible spectrum. Hence, each point represents a continuous light and sound correlation. To illustrate, in FIG. 4 points corresponding to the note F for eight octaves are marked (F0, . . . , F7). These points form an axis for notes F in all octaves. The change of perceived brightness of the color correlating to different octaves of this note is obvious in the diagram. Axis for any note sounds and for any another conceivable sub notes exists as well. Once a user points to a color on the diagram, the correlating sound is generated and displayed. The reverse is also possible such that a sound is pointed or input and the correlating color is located and displayed. The display apparatus can be in any physical or electronic form or format and any size with at least two-dimensional display. The sequencing of the color and sound correlation involved in this diagram is similar to the natural perception sequence in the human brain. This embodiment is uniquely useful for music education and illustrates the coupling of human sound and light cognition. The continuous correlation is especially useful to display on stringed instruments without discrete keys, such as violin. In another embodiment, the continuous light and sound correlation may be displayed by this apparatus attached to any music instrument.

FIG. 5 shows another embodiment of the invention. In this embodiment, the method is utilized for the manufacture of a color and sound correlating slide rule apparatus for referral, illustration, animation, and education purposes. This apparatus creates an effective medium for combining visual and/or auditory senses with hand movements. The color and sound correlating slide rule apparatus (50) comprises at least a stationary part (51) on which at least one of the light and sound correlation variables, i.e. colors or notes, are labeled and/or generated and at least one movable part (56) which moves relative to the stationary part(s) on which at least one of the other variables are labeled and/or generated and at least one correlating variable is displayed and/or generated. These parts may be in the form of any three-dimensional object, i.e. disc, plate, strip, cube, cylinder, sphere, etc. Moreover, the relative motion between the stationary and moving parts can be linear and/or rotational. In the preferred embodiment of the invention, both parts (51 and 56) are in the form of concentric circular disks, placed such that the moving part rotates on the stationary part. For easy rotating, there is provided at least one thumb lever (54) on the rotating part (56). In addition, for precise alignment, there is a pointer (52) on the stationary part. When the rotating part is aligned with the pointer on the stationary part, the correlating variable can be seen at a reference point. In the preferred embodiment of the invention, the reference point is a window (55) on the rotating part. This window (55) shows the color correlating to the musical note on the rotating part (56), which is aligned in front of the pointer. The reverse is also possible, i.e. aligning the window (55) to a desired color, so that the pointer (52) shows the correlating musical note. The color and sound correlating slide rule apparatus can be rotary, sliding, cylindrical, cubical, or in any other form, and may include sound and/or light output as another form of displaying sound and color correlation.

In one embodiment of the invention, a new CMIDI (Color Musical Instrument Digital Interface) file generating apparatus establishes a dynamic coupling among sound and light data (FIG. 6). This apparatus (60) receives an array of instrument and sound data per any time interval (61). Next, it is checked whether the sound data includes wavelength of sound (62). If this information is absent, wavelength of sound is calculated from present information (63). Each wavelength of sound is input into the light and sound correlation apparatus (64), which in turn calculates wavelength of light and perceived brightness, r. This information is arranged in the form of a data array, preferably a CMIDI file (65). CMIDI file is an array of data in any form, format, and content including color and sound data simultaneously. In the preferred embodiment, the sound data and correlated colors for multiple instruments or voices per time increment are recorded in separate columns. This data can be output to any storage or retrieval, printing, transmitting, display or animation device, depending on the desired form of output (66).

In another embodiment (FIGS. 7-12), the present invention is utilized to provide a visual orchestration apparatus where the sounds produced by instruments are dynamically displayed with colors on a respective layout. This layout has at least two dimensions and maps at least one music instrument, voice, (such as human voice), and/or sound sources. The present invention, which consists of a continuous correlation between sound and light, can colorize all sounds produced by any music instrument. These include sounds of western and non-western instruments, and the sounds produced are not limited to any discrete notation system. Furthermore, sounds from any source(s) like in nature can be mapped on a layout similar to an instrument layout and these sounds can be colorized and displayed on that layout. Hence, a visual orchestration of any combination of instruments or sounds sources are possible. This visual orchestration apparatus (80) is an apparatus comprising functions as a means of:
digitally defining a given or arranged instrument layout depending on the performance, composition, or sound source(s) (85) (FIG. 7);
developing a CMIDI file or data array compiled from a given performance, composition or sound source(s) (81) using the above explained CMIDI file generating apparatus (82), wherein the data array includes spatial information of instruments or sound sources on the layout (FIG. 9);
transferring generated CMIDI file to the instrument layout (83) (FIG. 10);
outputting the orchestration in the form of frames sequenced for each time increment wherein the colors of each sound are displayed (84) (FIG. 11).

To illustrate, the main orchestral sections on a standard orchestral layout are digitally identified with numbers 1 to 7 (FIG. 7) in the first step. Each orchestral section may also have subsections. Therefore, each instrument X is identified by a three number system X (j, q, w) where j is the section number, q is the subsection number, and w is the instrument number in that section. In the next step, the CMIDI file generating apparatus is used with the spatial information of the instruments defined by (j, q, w). The CMIDI file (FIG. 9) includes but is not limited to every note (Y) played by every orchestral instrument (X) for every time interval (s) correlated to the corresponding light wavelength (λₚ) and its distinct perceived color brightness (r). In the preferred embodiment, a measure of half step intervals from a known frequency (N) is calculated from the note and octave and provides the necessary information to calculate the wavelength of sound. In the following step, the generated CMIDI file is transferred to the instrumental layout for each time interval, wherein each correlated color is mapped on the instrument defined by the spatial information (FIG. 10 and 11). The magnitude or shape of the mapped colored area or colored surface on each instrument may vary in synchrony with the sound amplitude or waveform. A display frame is produced for each time interval of the colorized performance or composition and outputted to any display device. The output is generated on a real-time basis or stored for future display in any media format. The output of the visual orchestration apparatus provides a coupling of visual perception with musical sounds. The output may be used to recognize and locate sounds with color coupling, identify patterns in music or sounds with colors, treat tonal deafness, and train for perfect pitch etc.

In still another embodiment (FIG. 12), the visual orchestration embodiment is reverse engineered, so that it becomes an art composer apparatus (120). In this case, it becomes possible to compose music for a given artwork, photograph, image, piece of art etc. (121) by using the present invention. For this purpose, the artwork to be composed is discretized into small surface area fragments (grids) (122). The discretization grid has at least two dimensions. One dimension corresponds to the time frame. The other dimensions correspond to the instrument layout in the orchestra, which plays that art. For each grid surface area, color information is calculated (123). Then this information is input into the light and sound correlation apparatus (124) which in turn outputs the corresponding wavelength of sound for a given grid. Then the sound data is output in any suitable file format such as MIDI, mp3, etc. (127). If visual orchestration is also requested (125), wavelength of sounds is input into the visual orchestration apparatus (126). The time frame of orchestration is based on the time dimension of the image. On the other hand, the decision on which instrument to play the note corresponding to which grid is made based on the instrument layout dimension of the image. Hence the orchestra plays first a row (or column) of an image then the next rows. In each row, every grid area is assigned to a predetermined orchestral instrument. Thus in every time frame, every instrument plays the note corresponding to the color of the grid area of its column. Of course, within this scope, more complicated grid generation techniques and instrument assignments may be realized, such that instruments are assigned using a depth proportion between an instrument layout and an image in three dimensions. In this manner, it will become possible to combine the depth of sight in vision with depth of sound in hearing. The generated sounds can also be used by the visually impaired to hear images with sounds.

In still another embodiment of the invention, an apparatus, which produces sound data incorporating three-dimensional spatial information of an object, is developed. The spatial information is derived from the fact that the shades of colors change with depth. As the user, moves the pointer (131) across the image (132) of the three-dimensional object, the wavelength of light is calculated at every point of the displayed image and this data is simultaneously input into the light and sound correlation apparatus. The light and sound correlation apparatus generates sound data. This sound data is played using any sound generation apparatus (133) such as loudspeakers, etc. This apparatus is especially designed for individuals with William's Syndrome who have exceptional music ability but poor perception of depth. The sound generated gives a virtual perception of the depth of the image. It is possible to apply this embodiment in the form of a physical three-dimensional object, which is covered with a network of color-coded pressure sensors. As the user touches the object and moves his finger on the object, a correlating sound is generated to inform him/her about the depth of the object. This object may as well be an elastic blanket to be wrapped on various other objects the user might like to recognize by the light and sound correlation.

In another aspect of the invention, an apparatus is developed to provide a color language for the hearing impaired (FIG. 14). This apparatus couples any AV signal with colorized sounds to aid sound perception with visual perception. To illustrate, the hearing impaired can visually follow sounds in a music performance on a TV screen, on which a picture in picture box dynamically displays colorized instrument layout simultaneously with the main broadcast. This invention is in analogy with sign language used for news broadcast. The color language apparatus receives live or recorded AV input in any format (141) from two identical channels (142). One signal is used to arrange the instrument layout (143) and that signal is forwarded to the visual orchestration apparatus (144). The visual orchestration output in this channel is sent as a second AV input to any AV apparatus with picture in picture capability (145). The second input signal is forwarded ‘as is’ to the same AV apparatus where this original signal is displayed as the main AV picture, whereas the visual orchestration output signal is simultaneously displayed in the picture in picture AV frame (145).

From the descriptions above, a number of additional advantages become evident:

The accuracy and precision of the present method and apparatus are compatible with the the auditory and visual sensitivity of humans thanks to the continuous nature of the disclosed function, which provides a seamless and continous correlation between light and sound. Based on the continous color and sound correlation disclosed, the natural correlation in the human brain has been recognized and the correlation between depth of sounds and the depth of vision provides a superior combination of auditory and visual senses in the visual orchestration apparatus.

The present method and apparatus gives a one-to-one relationship to all sound and light wavelengths. In terms of music, this continuous function means a hypothetical piano with infinitesimally small half steps and additional octaves. The present method and apparatus can be applied to string instruments, such that the continous range of note sounds are represented with a continous light and sound correlation. Based on the continous color and sound correlation disclosed, a music composition written in one music system can be transferred to another music system such as from monophonic to polyphonic or vice versa.

In addition, the present method and apparatus are applicable at any ambient conditions with the same accuracy and precision because k is a number which can be proportionated to sound velocity. This is especially important in colorization of orchestration, because exact performance of instruments depend on ambient conditions. This method can accommodate and compensate changes in instrument performance and the medium. Provided that the correlation is based on wavelenghts, this method also eliminates the effect of the transmitting medium between the points of source and perception.

To summarize, the present invention discloses a direct and unique proportion between the wavelengths of visible light and audible sound that is seamless and continuous. The main strength of the present invention lies in the fact that it provides a universal correlation between wavelengths of sound and light. It can be applied to all wavelengths of light and sound, without any user intervention or dependency. Hence, it effectively utilizes the human color and sound cognitions without bias. This invention provides a universal method and apparatus capable of mutually correlating sound and light waves seamlessly, which satisfies long-felt human needs. As such, it will have many implications in science, engineering, medicine, art, music, education, and aiding the impaired. According to Harvard Dictionary of Music, “the physical and psychological relationship between colors and sound seems to be existent but quite difficult to obtain and characterize.” Finally, this invention has achieved the impossible.

While my above description contains many specifities, these should not be construed as limitations to the scope of the invention, but rather as an exemplification of various embodiments thereof. Many other variations are possible. Accordingly, the scope of the invention should be determined not by the embodiments illustrated, but by the appended claims and their legal equivalents.

1. A universal method of establishing a continuous, mutual correlation between sound and light, comprising the steps of:
inputting at least one wavelength, wavelength of light (λₚ), r and/or wavelength of sound (λₛ);
calculating the corresponding wavelength of sound and/or light using the equation:
$$( \frac{a}{r} ) \frac{{λ}_{s}^{m}}{{λ}_{p}^{n}} = k$$
outputting the calculated wavelength;
wherein, k is the only consistent correlation number that is unique among all wavelength combinations of note sounds and colors and reveals a continuous, seamless, and mutual correlation between light and sound, and related to a ratio of light and sound velocities, a is a term that relates sound wavelengths to an octave system, r is a number that represents the perceived brightness of light, and m and n are powers between 0.2≦m≦2 and 0.2≦n≦2.

2. The method of claim 1, if λₛ is an input, further comprising the steps of:
checking whether O′ is an input (102);
if O′ is not an input, calculating O′ from the equation (103):
$${O}^{′} = int ( log ( \frac{d}{{λ}_{s}} ) / e )$$
calculating r from O′ using the equation (104):
$$r = {2}^{( \frac{{O}^{′} + b}{2 \sqrt{π}} + c )}$$
then calculating the corresponding wavelength of light using the equation (105):
$${λ}_{p} = \frac{{λ}_{s}}{{( \frac{2 k r}{{2}^{( \frac{{O}^{′} + b}{2 \sqrt{ϕ}} )}} )}^{1 / m}}$$
outputting the calculated wavelength of light (λₚ), r (106);
wherein the b, c, d, and e are numbers −5≦b≦5, −2≦c≦2, 0.05≦d≦40, 0.1≦e≦1, and [symbol] is the Golden Ratio.

3. The method of claim 1 or 2, if λₚ, r are inputs, further comprising the steps of:
calculating O′ using the equation (107):
$${O}^{′} = int ( ( \frac{log r}{log 2} - c ) \times 2 \sqrt{π} - b )$$
then calculating the corresponding wavelength of sound using the equation (108):
$${λ}_{s} = {λ}_{p} \times {( \frac{2 k r}{{2}^{( \frac{{O}^{′} + b}{\sqrt{ϕ}} )}} )}^{1 / m}$$
outputting the calculated wavelength of sound (λₛ) and O′ (106).

4. A mutual sound and light correlation apparatus exploiting said method according to any one of claims 1 to 3, characterized in that it is a device capable of performing said calculations of the method, and outputs the wavelength of sound and/or light when any wavelength of light and/or sound is input along with other relevant data.

5. An apparatus according to claim 4, characterized in that the inputs are realized through an input interface comprising a keyboard, a keypad, a mouse, a device measuring wavelength of sound and/or light, a touch-screen, a graphics interface, sensor, measurement device etc.

6. An apparatus according to claim 4 and 5, characterized in that the outputs are realized through an output interface comprising any sound and/or light generator and/or graphics generator.

7. An apparatus according to claims 4 to 6, in the form of a continuous color and sound correlation display apparatus, wherein all wavelengths in the audible sound range are correlated with light wavelengths on several layers of the visible light gamut such that a layer is constructed for each octave with corresponding perceived brightness, and then these layers are superimposed, on which a user may point physically or electronically to a color to hear and/or read the correlating sound, or may point physically or electronically to a sound to see and/or read the correlating color, wherein the color and sound correlation is displayed in at least two dimensions.

8. An apparatus according to claim 7, characterized in that said continuous light and sound correlation is displayed by this apparatus attached to any music instrument.

9. An apparatus according to claims 4 to 6, in the form of a color and sound correlation slide rule apparatus (50), which comprises at least a stationary part (51) on which at least one variable of the light and sound correlation, i.e. colors or notes, is labeled and/or generated and at least a movable part (56), which moves relative to the stationary part(s) on which at least one of the other variables is labeled and/or generated and at least one correlating variable is displayed.

10. An apparatus according to claim 9, characterized in that said parts are in the form of any three-dimensional object wherein the relative motion between parts is linear and/or rotational.

11. An apparatus according to claim 9 or 10, characterized in that parts (51 and 56) are in the form of concentric circular disks, placed such that the moving part rotates on the stationary part and that it comprises at least one thumb lever (54) on the rotating part (56), and a pointer (52) on the stationary part, such that, when the rotating part is aligned with the pointer on the stationary part, the corresponding variable can be seen at a reference point.

12. An apparatus according to claim 11, characterized in that said reference point is a window (55) on the rotating part, which shows the color correlating to the musical note on the rotating part (56) in front of the pointer.

13. An apparatus according to claims 4 to 6, in the form of a CMIDI (Color Musical Instrument Digital Interface) file generating apparatus, which receives an array of instrument and sound information per any time interval (61), next, checks whether the sound information includes wavelength of sound (62), then if said information is absent, calculates wavelength of sound from the present information (63), then inputs each wavelength of sound into the light and sound correlation apparatus (64), which in turn calculates wavelength of light and perceived brightness, r, which information is arranged in the form of a data array, preferably a CMIDI file (65) which is in turn transferred to any storage or retrieval, printing, transmitting, display or animation device, depending on the desired form of output (66).

14. An apparatus according to claims 4 to 6, in the form of a visual orchestration apparatus (80) comprising functions as a means of:
digitally defining a given or arranged instrument layout depending on instruments in a performance, composition, or sound sources (85);
developing a CMIDI file or data array compiled from a given performance, composition, or sound sources (81) using the above explained CMIDI file generating apparatus (82), wherein the data array includes spatial information of instruments or sound sources on the layout;
transferring the generated CMIDI file to the instrument layout (83);
outputting the orchestration in the form of frames sequenced for each time increment wherein the colors of each sound are displayed (84).

15. An apparatus according to claims 4 to 6, for composing music for a given artwork, photograph, image, piece of art etc. (121), which discretizes said image into small surface area fragments (grids) (122) such that the discretization grid has at least two dimensions wherein one dimension corresponds to the time frame and the other dimensions correspond to the instrument layout in the orchestra, then for each grid surface area, calculates color information (123), then inputs this information into the light sound correlation apparatus (124) which in turn outputs the corresponding wavelength of sound for a given grid, and outputs the sound data in any suitable file format such as MIDI, mp3, etc. (127).

16. An apparatus according to claim 15, characterized in that if visual orchestration is also requested (125), wavelength of sounds is input into the visual orchestration apparatus (126).

17. An apparatus according to claims 4 to 6, which derives spatial information according to the shades of colors that change with depth, and as the user, moves the pointer (131) across the image (132) of the three dimensional object, calculates the wavelength of light at every point of the image, simultaneously inputs this data into the light sound correlation apparatus, and plays the generated sound data using any sound generation apparatus (133) such as loudspeakers, etc.

18. An apparatus according to claim 17, characterized in that it is in the form of a physical three-dimensional object, which is covered with a network of color coded pressure sensors, such that as the user touches the object and moves his finger on the object, a correlating sound is generated to inform him/her about the depth of the object.

19. An apparatus according to claim 18, characterized in that it is in the form of an elastic blanket to be wrapped on various other objects the user might like to recognize by the light and sound correlation.

20. An apparatus according to claims 4 to 6, characterized in that it receives live or recorded AV input in any format (141) from two identical channels (142), uses one signal to arrange the instrument layout (143) and forwards that signal to the visual orchestration apparatus (144), wherein the visual orchestration output in this channel is sent as a second AV input to any AV apparatus with picture in picture capability (145) and the second input signal is forwarded ‘as is’ to the same AV apparatus where this original signal is displayed as the main AV picture, whereas the colorized AV signal is simultaneously displayed in the picture in picture AV frame (145).
